(19) United States
(12) Patent Application Publication
(10) Pub. No.: US 2025/0264758 A1
(43) Pub. Date: Aug. 21, 2025

(54) DISPLAY APPARATUS HAVING A BACK-LIGHT UNIT

(71) Applicant: LG Display Co., Ltd., Seoul (KR)

(72) Inventors: Myung Won SEO, Paju-si (KR); Ki Sung LIM, Paju-si (KR); Jin Su MOON, Paju-si (KR); Ki Seong KIM, Paju-si (KR)

(73) Assignee: LG Display Co., Ltd., Seoul (KR)

(21) Appl. No.: 18/987,495

(22) Filed: Dec. 19, 2024

(30) Foreign Application Priority Data
Feb. 20, 2024 (KR) 10-2024-0024488

(51) Int. Cl. G02F 1/13357

(52) U.S. Cl. CPC G02F 1/133606; G02F 1/133603

(57) ABSTRACT

A display apparatus including a back-light unit is provided. The display apparatus may include a back-light unit including a light source unit and an optical sheet on the light source unit, a light path conversion unit on the optical sheet of the back-light unit, and a display panel on the light path conversion unit. The light source unit may include a plurality of first light source devices, a plurality of second light source devices, and a plurality of light guide patterns. The first light source devices may be spaced apart from the second light source devices and the light guide patterns and may be configured to emit light toward the light conversion unit. Each of the second light source devices may be configured to emit light toward a side of at least one of the light guide patterns.

This application claims the benefit of and priority to Korean Patent Application No. 10-2024-0024488, filed on Feb. 20, 2024, which is hereby incorporated by reference as if fully set forth herein.

### BACKGROUND

### Technical Field

The present disclosure relates to a display apparatus using light provided by a back-light unit.

### Discussion of the Related Art

Generally, a display apparatus provides an image to a user. The display apparatus can render the image using light provided by a back-light unit. For example, the display apparatus can include a liquid crystal panel disposed on the back-light unit.

The display apparatus can be used in various places. For example, the display apparatus can be installed in front of a passenger seat of a vehicle. The image rendered by the display apparatus can be recognized by people disposed around the user, for example, a driver sitting in a driver's seat. Thus, the image rendered by the display apparatus can disperse the driver's gaze. Therefore, the image rendered by the display apparatus can increase a possibility or risk of an accident by the people disposed around the user.

### SUMMARY

Accordingly, the present disclosure is directed to a display apparatus that substantially obviates one or more problems due to limitations and disadvantages of the related art.

An object of the present disclosure is to provide a display apparatus capable of selectively changing the viewing angle.

Another object of the present disclosure is to provide a display apparatus capable of effectively controlling the path of the light provided to render the image.

Additional advantages, objects, and features of the present disclosure will be set forth in part in the description which follows and in part will become apparent to those having ordinary skill in the art upon examination of the following description or may be learned from practice of the disclosure. Other objectives and advantages of the present disclosure may be realized and attained by the structure particularly pointed out in, or derivable from, the written description, claims hereof, and the appended drawings.

To achieve these objects and other advantages of the disclosure, as embodied and broadly described herein, a display apparatus may include a back-light unit including a light source unit and an optical sheet on the light source unit, a light path conversion unit on the optical sheet of the back-light unit, and a display panel on the light path conversion unit. The light source unit may include a plurality of first light source devices, a plurality of second light source devices, and a plurality of light guide patterns. The first light source devices may be spaced apart from the second light source devices and the light guide patterns and may be configured to emit light toward the light conversion unit. Each of the second light source devices may be configured to emit light toward a side of at least one of the light guide patterns.

The light source unit may further include a base substrate disposed parallel to the optical sheet, and the first light source devices, the second light source devices, and the light guide patterns may be disposed side by side on the base substrate.

Each of the second light source devices may have a different planar shape from each of the first light source devices.

Each of the second light source devices may have a planar shape extending along a side of at least one of the light guide patterns.

A number of the second light source devices may be different from one or both of a number of the first light source devices and a number of the light guide patterns.

The display apparatus may further comprise a control circuit configured to selectively control: the first light source devices to emit light while the second light source devices do not emit light; and the second light source devices to emit light while the first light source devices do not emit light.

The light path conversion unit may include a first control electrode, a second control electrode, and a variable diffusion layer disposed between the first control electrode and the second control electrode. The variable diffusion layer may include a polymer dispersed liquid crystal (PDLC).

The display apparatus may further comprise a control circuit configured to: control the first light source devices to emit light while a voltage is not applied to the first control electrode and the second control electrode; and control the second light source devices to emit light while a voltage is applied to the first control electrode and the second control electrode.

The first control electrode and the second electrode may include a transparent conductive material.

The first control electrode may include a plurality of electrode patterns spaced apart from each other. Each of the electrode patterns may overlap at least one of the light guide patterns.

Each of the first light source devices may be surrounded by the second light source devices and the light guide patterns. Each of the second light source devices may be disposed between the first light source devices.

The optical sheet may include a base sheet and a plurality of prisms disposed on a lower surface of the base sheet facing toward the light source unit, the plurality of prisms extending parallel to each other in a first direction.

An upper surface of the light guide pattern facing toward the optical sheet may include a plurality of protrusions. A cross-section of each of the plurality of protrusions may have a shape corresponding to a cross-section of each of the plurality of prisms. The plurality of protrusions may extend in a second direction intersecting the first direction.

In another aspect of the present disclosure, a display apparatus may include a back-light unit, a liquid crystal panel on the back-light unit, and a light path conversion unit disposed between the back-light unit and the liquid crystal panel. The back-light unit may include a base substrate, a light source unit on an upper surface of a base substrate toward the light path conversion unit, and an optical sheet between the light source unit and the light path conversion unit. The light source unit may include a first light source device configured to emit light toward the light path conversion unit, a light guide pattern spaced apart from the first light source device, and a second light source device disposed at a side of the light guide pattern. Light transmitted to the light path conversion unit by the second light source device via the light guide pattern may have a higher straightness than the light emitted from the first light source device to the light path conversion unit.

A corner area of the light guide pattern toward the first light source device may have a chamfer shape.

The optical sheet may include a base sheet and a plurality of prisms disposed on the base sheet. The plurality of prisms may extend parallel to each other in a first direction.

The plurality of prisms may be disposed on a lower surface of the base sheet facing toward the light source unit.

An upper surface of the light guide pattern facing toward the optical sheet may include a plurality of protrusions. A cross-section of each of the plurality of protrusions may have a shape corresponding to a cross-section of each of the plurality of prisms. The plurality of protrusions may extend in a second direction intersecting the first direction.

The display apparatus may further include a control circuit configured to selectively control: the first light source devices to emit light while the second light source devices do not emit light; and the second light source devices to emit light while the first light source devices do not emit light.

The light path conversion unit may include a first control electrode, a second control electrode, and a variable diffusion layer disposed between the first control electrode and the second control electrode. The variable diffusion layer may include a polymer dispersed liquid crystal (PDLC).

It is to be understood that both the foregoing general description and the following detailed description of the present disclosure are by way of example and are intended to provide further explanation of the disclosures as claimed.

### BRIEF DESCRIPTION OF DRAWINGS

The accompanying drawings, which are included to provide a further understanding of the invention and are incorporated in and constitute a part of this application, illustrate example embodiment(s) of the disclosure and together with the description serve to explain the principles of the disclosure. In the drawings:

FIG. 1 is a view showing an example environment where a display apparatus according to an example embodiment of the present disclosure may be used;

FIG. 2 is a view schematically showing a cross-section of a display apparatus according to an example embodiment of the present disclosure;

FIG. 3 is a view showing a plane of a light source unit in the display apparatus according to the example embodiment of the present disclosure;

FIG. 4 is a view showing a path of light in the display apparatus according to the example embodiment of the present disclosure, when an image of a wide viewing angle mode is realized;

FIG. 5 is a view showing a path of light in the display apparatus according to the example embodiment of the present disclosure, when an image of a narrow viewing angle mode is realized;

FIG. 6 is a view showing first light source devices recognized by a user depending on the presence or absence of a light path conversion unit, when an image of a wide viewing angle mode is rendered; and

FIGS. 7 to 13 are views showing a display apparatus according to other example embodiments of the present disclosure.

### DETAILED DESCRIPTION

Hereinafter, advantages and features of the present disclosure and methods of achieving them will become apparent with reference to the example embodiments described below in detail in conjunction with the accompanying drawings. The present disclosure may, however, be embodied in different forms and should not be construed as limited to the example embodiments set forth herein. Rather, these example embodiments are provided so that this disclosure will be thorough and complete and will fully convey the scope of the present disclosure to those skilled in the art.

Same reference numerals generally correspond to the same or similar components throughout the specification, unless otherwise specified. Also, in the drawings, such dimensions as lengths and thicknesses of components or regions may be exaggerated for convenience in description, but the present disclosure is not limited to such illustrated details in the drawings.

Where a first element is described as being “on” a second element, the first element may be directly “on” so as to contact the second element or may be indirectly “on” the second element with a third element interposed between them.

Although terms “first,” “second,” and the like may be used herein to describe various elements, these elements should not be interpreted to be limited by these terms as they are not used to define a particular essence, order, sequence, precedence, or number of such elements. These terms are used only to refer one element separately from another. For example, a first element could be termed a second element, and a second element could similarly be termed a first element, without departing from the scope of the present disclosure.

The terms used in the specification of the present disclosure are merely used to describe particular example embodiments and are not intended to limit the scope of the present disclosure. For example, an element described in a singular form is intended to include a plurality of elements, and vice versa, unless the context clearly indicates otherwise. In addition, in the specification of the present disclosure, such terms as “comprise,” “include,” and the like are intended to identify the non-exclusive presence of stated features, integers, steps, operations, elements, components, and/or combinations thereof, and are not intended to preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which example embodiments belong. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

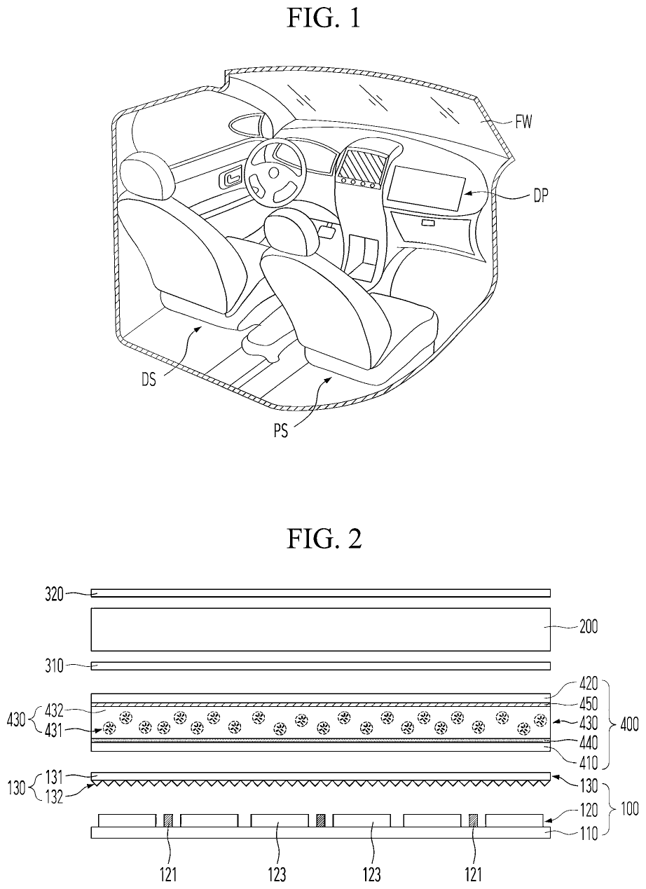

FIG. 1 is a view showing an example environment where a display apparatus according to an example embodiment of the present disclosure may be used.

As shown in FIG. 1, the display apparatus DP according to the example embodiment of the present disclosure may be installed in a vehicle. For example, the display apparatus DP according to the example embodiment of the present disclosure may be installed in front of a passenger seat PS of a vehicle. The display apparatus DP according to the example embodiment of the present disclosure may be controlled by a user sitting in a passenger seat PS of a vehicle. For example, in the display apparatus DP according to the example embodiment of the present disclosure, an image of a wide viewing angle mode that is shared between the user (in the passenger seat PS) and a driver sitting in the driver's seat DS and an image of a narrow viewing angle mode not visible or readily visible to the driver can be selectively rendered. Thus, in the display apparatus DP according to the example embodiment of the present disclosure, the dispersion of the driver's gaze may be prevented by the narrow viewing angle mode. For example, in the display apparatus DP of the example embodiment of the present disclosure, a possibility or risk of an accident due to the dispersion of the driver's gaze while driving the vehicle can be greatly reduced. As another example, with the display apparatus according to the example embodiment of the present disclosure, the user can select the narrow viewing angle mode to prevent others nearby from viewing the image rendered on the display apparatus when the displayed information is not appropriate for viewing by others, e.g., due to the confidentiality or privacy of the displayed information.

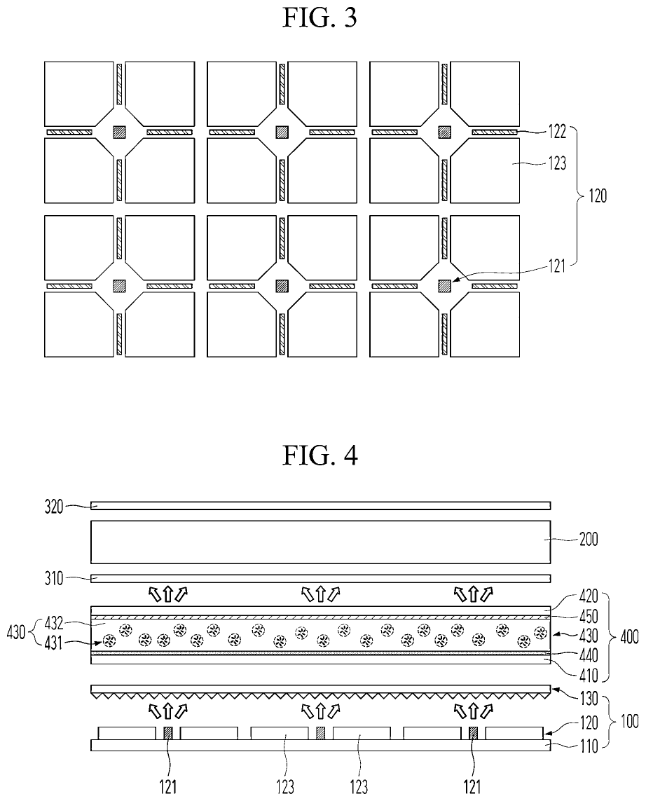

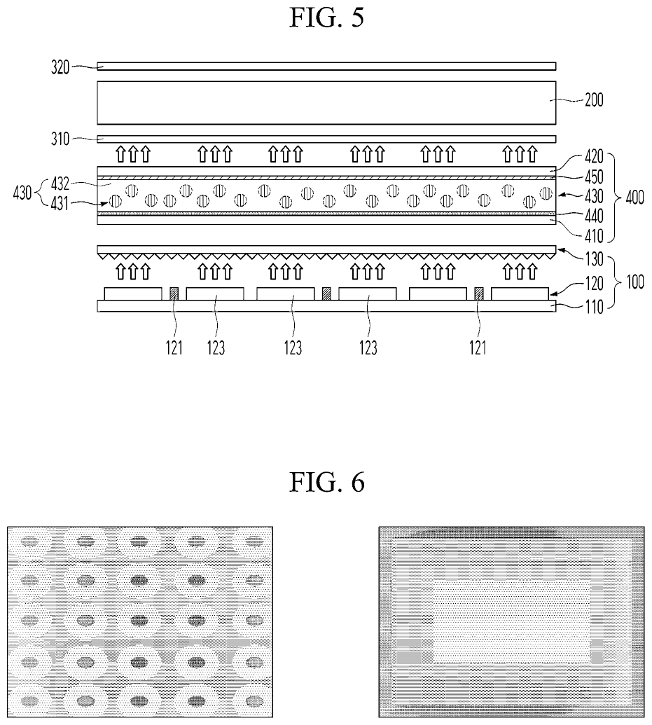

FIG. 2 is a view schematically showing a cross-section of the display apparatus according to the example embodiment of the present disclosure. FIG. 3 is a view showing a plane of a light source unit in the display apparatus according to the example embodiment of the present disclosure.

As illustrated in FIGS. 2 and 3, the display apparatus DP according to the example embodiment of the present disclosure may include a liquid crystal panel 200 disposed on a back-light unit 100. The liquid crystal panel 200 can render an image provided to a user using light provided from the back-light unit 100. For example, the liquid crystal panel 200 may include a liquid crystal layer disposed between a pixel electrode and a common electrode. The liquid crystal layer may include a liquid crystal of, for example, IPS mode, ECB mode, or TN mode. For example, the liquid crystal panel 200 can render images with various brightness and contrast by using rotation of the liquid crystal due to an electric field formed between the pixel electrode and the common electrode.

The liquid crystal panel 200 may be disposed between a first linear polarizer 310 and a second linear polarizer 320. For example, the first linear polarizer 310 may be disposed between the back-light unit 100 and the liquid crystal panel 200. A transmission axis of the second linear polarizer 320 may be perpendicular to a transmission axis of the first linear polarizer 310. That is, when the liquid crystal layer of the liquid crystal panel 200 is not rotated, light provided to the liquid crystal panel 200 through the first linear polarizer 310 may be blocked by the second linear polarizer 320 in the display apparatus according to the example embodiment of the present disclosure. Thus, in the display apparatus according to the example embodiment of the present disclosure, a contrast ratio can be improved.

The back-light unit 100 can emit light toward the liquid crystal panel 200. For example, the back-light unit 100 may include a base substrate 110, a light source unit 120, and an optical sheet 130. The liquid crystal panel 200 may be disposed on the optical sheet 130. The base substrate 110 may be disposed parallel to the optical sheet 130. The light source unit 120 may be disposed on an upper surface of the base substrate 110 toward the optical sheet 130. For example, in the display apparatus according to the example embodiment of the present disclosure, the back-light unit 100 may be a direct type back-light unit in which light emitted from the light source unit 120 is directly irradiated to an entire surface of the liquid crystal panel 200.

The light source unit 120 may include first light source devices 121, second light source devices 122, and light guide patterns 123. The first light source devices 121 and the second light source devices 122 can be selectively operated. For example, when the first light source devices 121 emit light, the second light source devices 122 may not emit light. The second light source devices 122 may be disposed side by side on the base substrate 110. For example, the base substrate 110 may include at least one control circuit to control the operation of the first light source devices 121 and the operation of the second light source devices 122. The second light source devices 122 may be disposed on a same layer as the first light source devices 121.

Each of the first light source devices 121 may be a device generating and emitting light. For example, each of the first light source devices 121 may include a light emitting diode (LED). Each of the first light source devices 121 can emit light toward the liquid crystal panel 200. For example, the light generated by each first light source device 121 may be emitted through a surface of the corresponding first light source device 121 toward the optical sheet 130. The first light source devices 121 may be disposed regularly, e.g., at a regular interval. For example, a distance between two adjacent first light source devices 121 in a first direction may be the same as a distance between two adjacent first light source devices 121 in a second direction perpendicular to the first direction. The first light source devices 121 may be arranged in a matrix form. Thus, in the display apparatus according to the example embodiment of the present disclosure, the light emitted from the first light source devices 121 can be uniformly supplied to the entirely surface of the liquid crystal panel 200.

Each of the second light source devices 122 may be a device generating and emitting light. For example, each of the second light source devices 122 may include a light emitting diode (LED). The light emitted from each second light source device 122 can be provided to the liquid crystal panel 200 through one of the light guide patterns 123. For example, each of the second light source devices 122 may be disposed on a side of at least one of the light guide patterns 123. The light generated by each second light source device 122 can be emitted toward the side of the corresponding light guide pattern 123. The second light source devices 122 may be disposed between the first light source devices 121. For example, each of the first light source devices 121 may be surrounded by the second light source devices 122 and the light guide patterns 123. The number of the second light source devices 122 may be different from the number of the first light source devices 121. A corner area of each light guide pattern 123 adjacent to the first light source devices 121 may have a chamfer shape. Thus, in the display apparatus according to the example embodiment of the present disclosure, a potential damage to the first light source devices 121 due to the light guide patterns 123 can be prevented or mitigated.

A plane of each second light source device 122 may have a different shape from a plane of each first light source device 121. For example, each of the second light source devices 122 may have a shape extending along a side of one of the light guide patterns 123. Thus, in the display apparatus according to the example embodiment of the present disclosure, the amount of the light provided to the liquid crystal panel 200 through the second light source devices 122 and the light guide patterns 123 can be maximized.

Each of the light guide patterns 123 can transmit the light provided from at least one of the second light source devices 122 toward the liquid crystal panel 200. For example, in the display apparatus according to the example embodiment of the present disclosure, each of the light guide patterns 123 can function as a planar light source. Thus, in the display apparatus according to the example embodiment of the present disclosure, the light provided to the liquid crystal panel 200 by the second light source devices 122 and the light guide patterns 123 can have a higher straightness than the light provided to the liquid crystal panel 200 by the first light source devices 121. Therefore, in the display apparatus according to the example embodiment of the present disclosure, the straightness and the diffusion of the light provided from the back-light unit 100 to the liquid crystal panel 200 can be selectively controlled. That is, in the display apparatus according to the example embodiment of the present disclosure, the light provided from the back-light unit 100 to the liquid crystal panel 200 can have different characteristics in the wide viewing angle mode and the narrow viewing angle mode. For example, in the display apparatus according to the example embodiment of the present disclosure, the light having a relatively high diffusion characteristic can be provided to the liquid crystal panel 200 by the first light source devices 121 of the back-light unit 100 in the wide viewing angle mode, and the light having a relatively high straightness characteristic can be provided to the liquid crystal panel 200 by the second light source devices 122 and the light guide patterns 123 of the back-light unit 100 in the narrow viewing angle mode.

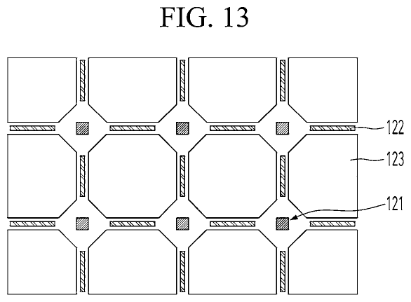

Uniformity of the light provided from the light source unit 120 to the liquid crystal panel 200 can be improved by the optical sheet 130. The directivity of the light emitted from the light source unit 120 can be corrected by the optical sheet 130. For example, the optical sheet 130 may be a prism sheet including a base sheet 131 and a plurality of prisms 132 (see FIG. 7). The plurality of prisms 132 may be disposed side by side on a surface of the base sheet 131. For example, the plurality of prisms 132 may be disposed on a lower surface of the base sheet 131 toward the base substrate 110. The plurality of prisms 132 may extend parallel to each other in a direction.

A light path conversion unit 400 may be disposed between the back-light unit 100 and the liquid crystal panel 200. The light path conversion unit 400 can improve the diffusion or the straightness of the light provided from the back-light unit 100 to the liquid crystal panel 200. For example, the light path conversion unit 400 may include a variable diffusion layer 430 disposed between a first control substrate 410 and a second control substrate 420, a first control electrode 440 disposed between the first control substrate 410 and the variable diffusion layer 430, and a second control electrode 450 disposed between the variable diffusion layer 430 and the second control substrate 420. The first control substrate 410 and the second control substrate 420 may include an insulating material. The first control substrate 410 and the second control substrate 420 may include a transparent material. For example, the first control substrate 410 and the second control substrate 420 may be glass or plastic. The second control substrate 420 may include a same material as the first control substrate 410.

The first control electrode 440 and the second control electrode 450 may include a conductive material. The first control electrode 440 and the second control electrode 450 may include a material having high transmittance. For example, the first control electrode 440 and the second control electrode 450 may be a transparent electrode made of a transparent conductive material, such as ITO and IZO. The second control electrode 450 may include a same material as the first control electrode 440.

The first control electrode 440 may extend along between the first control substrate 410 and the variable diffusion layer 430. The second control electrode 450 may extend along between the variable diffusion layer 430 and the second control substrate 420. A plane of the second control electrode 450 may have a same size as a plane of the first control electrode 440. For example, a change in characteristics of the light passing through the variable diffusion layer 430 may be the same as a whole.

The diffusion or the straightness of the light passing through the variable diffusion layer 430 may vary according to a voltage difference between the first control electrode 440 and the second control electrode 450. For example, the variable diffusion layer 430 may include a polymer dispersed liquid crystal (PDLC) in which droplets 431 containing fine-sized liquid crystal molecules are dispersed within a polymer insulating layer 432. When a voltage is not applied to the first control electrode 440 and the second control electrode 450, the liquid crystal molecules of the polymer dispersed liquid crystal (PDLC) can be arranged irregularly. Thus, in the display apparatus according to the example embodiment of the present disclosure, the diffusion of the light passing through the variable diffusion layer 430 may be increased when a voltage is not applied to the first control electrode 440 and the second control electrode 450. When a voltage is applied to the first control electrode 440 and the second control electrode 450, the liquid crystal molecules of the polymer dispersed liquid crystal (PDLC) can be arranged regularly. For example, the liquid crystal molecules of the polymer dispersed liquid crystal (PDLC) can be vertically aligned when a voltage is applied to the first control electrode 440 and the second control electrode 450. Therefore, in the display apparatus according to the example embodiment of the present disclosure, the straightness of the light passing through the variable diffusion layer 430 can be increased when a voltage is applied to the first control electrode 440 and the second control electrode 450.

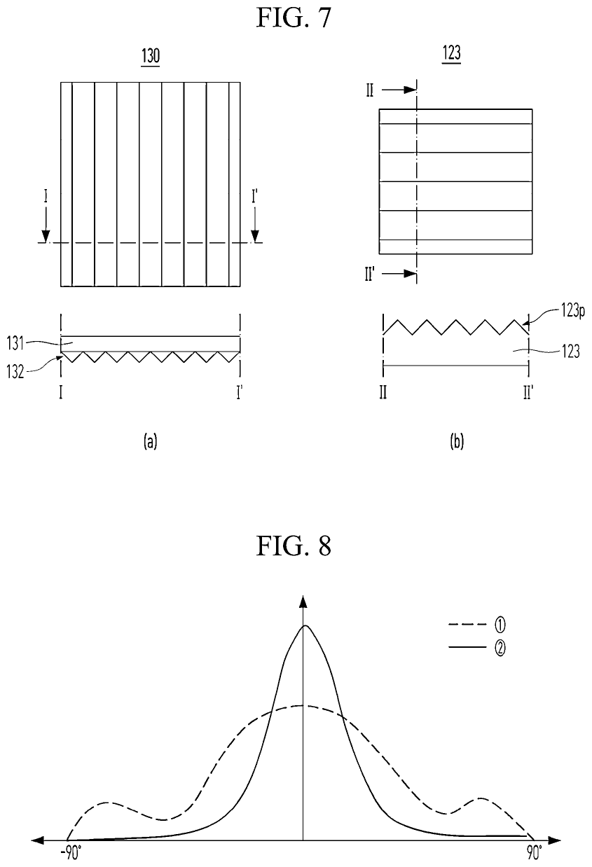

FIG. 4 is a view showing a path of light in the display apparatus according to the example embodiment of the present disclosure, when an image of the wide viewing angle mode is rendered.

As illustrated in FIG. 4, in the wide viewing angle mode of the display apparatus according to the example embodiment of the present disclosure, the first light source devices 121 of the back-light unit 100 can be configured to emit the light while a voltage is not applied to the first control electrode 440 and the second control electrode 450 of the light path conversion unit 400. Thus, in the wide viewing angle mode of the display apparatus according to the example embodiment of the present disclosure, the diffusion of the light emitted from each first light source device 121 can be increased by the light path conversion unit 400. That is, in the wide viewing angle mode of the display apparatus according to the example embodiment of the present disclosure, the light provided to the liquid crystal panel 200 can have a high diffusion. Therefore, in the wide viewing angle mode of the display apparatus according to the example embodiment of the present disclosure, an image visible to people disposed around the user can be rendered.

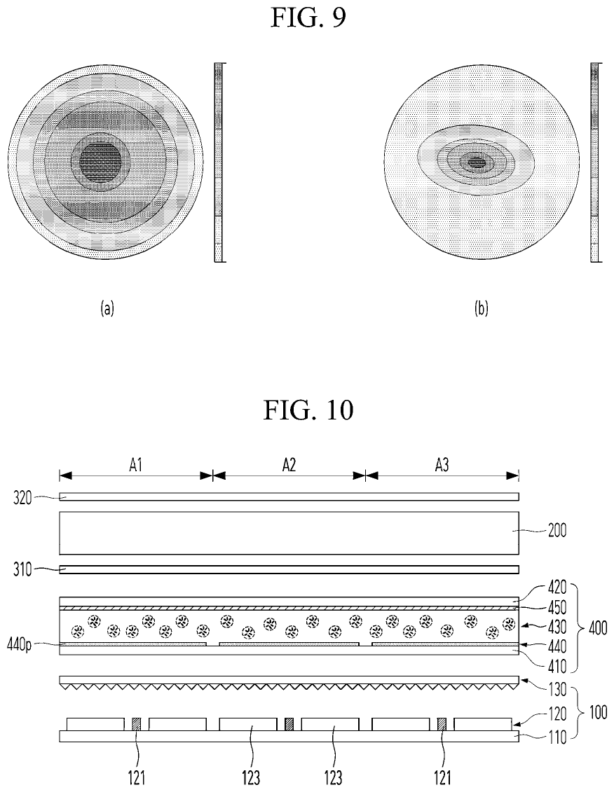

FIG. 5 is a view showing a path of light in the display apparatus according to the example embodiment of the present disclosure, when an image of a narrow viewing angle mode is rendered.

As shown in FIG. 5, in the narrow viewing angle mode of the display apparatus according to the example embodiment of the present disclosure, the second light source devices 122 of the back-light unit 100 can be configured to emit the light while a voltage is applied to the first control electrode 440 and the second control electrode 450 of the light path conversion unit 400. The light emitted from each second light source device 122 can be provided to the light path conversion unit 400 through at least one of the light guide patterns 123. The liquid crystal molecules of the variable diffusion layer 430 can be vertically aligned by the voltage applied to the first control electrode 440 and the second control electrode 450. Thus, in the narrow viewing angle mode of the display apparatus according to the example embodiment of the present disclosure, the straightness of the light emitted by the second light source devices 122 and the light guide patterns 123 can be increased by the light path conversion unit 400. That is, in the narrow viewing angle mode of the display apparatus according to the example embodiment of the present disclosure, the light provided to the liquid crystal panel 200 can have a high straightness. Therefore, in the narrow viewing angle mode of the display apparatus according to the example embodiment of the present disclosure, an image that is not visible or readily visible to the people disposed around the user can be rendered.

Accordingly, the display apparatus according to the example embodiment of the present disclosure may include the light path conversion unit 400 disposed between the back-light unit 100 and the liquid crystal panel 200, wherein the back-light unit 100 may include the first light source devices 121, the second light source devices 122, and the light guide patterns 123. The back-light unit 100 can selectively emit the light having a high diffusion characteristic or a high straightness characteristic, and the diffusion or the straightness of the light provided from the back-light unit 100 to the liquid crystal panel 100 can be increased by the light path conversion unit 400. That is, in the display apparatus according to the example embodiment of the present disclosure, the light having a high diffusion characteristic can be emitted from the back-light unit 100 in the wide viewing angle mode, the light having a high straightness characteristic can be emitted from the back-light unit 100 in the narrow viewing angle mode, and the diffusion or the straightness of the light emitted from the back-light unit 100 can be increased by the light path conversion unit 400. Thus, in the display apparatus according to the example embodiment of the present disclosure, visibility of the image rendered in the wide viewing angle mode to the people disposed around the user can be greatly increased, and an image can be rendered in the narrow viewing angle mode so as to be not visible or not readily visible to the people disposed around the user. Therefore, in the display apparatus according to the example embodiment of the present disclosure, a possibility or risk of an accident due to the dispersion of the gaze of the driver sitting next to the user (e.g., the passenger) in the narrow viewing angle mode can be greatly reduced. Likewise, with the display apparatus according to the example embodiment of the present disclosure, the user can select the narrow viewing angle mode when the image rendered on the display apparatus is not appropriate for viewing by others nearby, e.g., due to the confidentiality or privacy of the information displayed.

And, in the display apparatus according to the example embodiment of the present disclosure, the second light source devices 122 may be configured not to emit light in the wide viewing angle mode, and the first light source devices 121 may configured not to emit light in the narrow viewing angle mode. Thus, in the display apparatus according to the example embodiment of the present disclosure, lower power driving can be possible in the wide viewing angle mode and in the narrow viewing angle mode. Therefore, in the display apparatus according to the example embodiment of the present disclosure, power consumption can be reduced by the lower power driving.

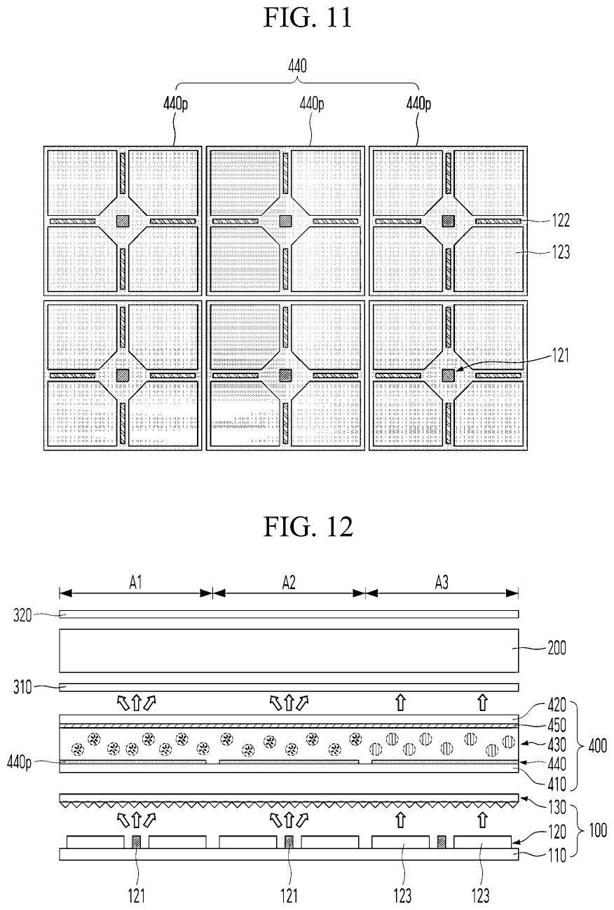

FIG. 6 is a view showing the visibility of the first light source devices 121 to a user in the wide viewing angle mode (a) in a comparative display apparatus that does not include a light path conversion unit and (b) in the display apparatus according to the example embodiment of the present disclosure.

As shown in FIG. 6, (a) the first light source devices 121 of the comparative display apparatus can be recognized by the user, and (b) the first light source devices 121 of the display apparatus according to the example embodiment of the present disclosure can be configured not to be recognizable to the user. That is, in the display apparatus according to the example embodiment of the present disclosure, the light emitted from each first light source device 121 can be diffused by the variable diffusion layer 430 of the light path conversion unit 400, so that the first light source devices 121 can be configured not to be visible to the user. Thus, in the display apparatus according to the example embodiment of the present disclosure, the visibility and the quality of the image rendered in the wide viewing angle mode can be improved.

Accordingly, the display apparatus according to the example embodiment of the present disclosure may include the back-light unit 100, the light path conversion unit 400, and the liquid crystal panel 200, wherein the light source unit 120 of the back-light unit 100 may include the first light source devices 121, the second light source devices 122, and the light guide patterns 123, which are disposed side by side on the base substrate 110. The optical sheet 130 of the back-light unit 100 disposed on the light source unit 120 of the back-light unit 100 may be a prism sheet including a plurality of prisms 132, and the light path conversion unit 400 may be disposed between the optical sheet 130 and the liquid crystal panel 200. Thus, in the display apparatus according to the example embodiment of the present disclosure, the light having a high diffusion characteristic can be emitted from the light source unit 120 of the back-light unit 100 in the wide viewing angle mode, the light having a high straightness characteristic can be emitted from the light source unit 120 of the back-light unit 100 in the narrow viewing angle mode, and the diffusion or the straightness of the light provided from the back-light unit 100 to the liquid crystal panel 200 can be increased by the light path conversion unit 400 including the polymer dispersed liquid crystal (PDLC). Therefore, in the display apparatus according to the example embodiment of the present disclosure, visibility of the image rendered in the wide viewing angle mode to the people disposed around the user can be greatly increased. And, in the display apparatus according to example the embodiment of the present disclosure, visibility of the image rendered in the narrow viewing angle mode to the people disposed around the user can be greatly reduced, so that the people disposed around the user cannot recognize or cannot readily recognize the image rendered in the narrow viewing angle mode. That is, in the display apparatus according to the example embodiment of the present disclosure, the dispersion of the gaze of the people disposed around the user can be prevented in the narrow viewing angle mode.

In the display apparatus according to another example embodiment of the present disclosure, a pattern may be formed at an upper surface of each light guide pattern 123 toward the optical sheet 130 to improve the straightness of the light. For example, in the display apparatus according to another example embodiment of the present disclosure, a plurality of protrusions 123p may be disposed at the upper surface of each light guide pattern 123, the plurality of protrusions 123p may extend in a direction intersecting the plurality of prisms 123, and a cross-section of each protrusion 123p may have a shape corresponding to a cross-section of each prism 123, as shown in FIG. 7. Thus, in the display apparatus according to another example embodiment of the present disclosure, the straightness of the light passing through the upper surface of each light guide pattern 123 and the optical sheet 130 can be greatly improved.

FIG. 8 is a view showing light intensities according to viewing angle of the first light \textcircled{1} emitted from the back-light unit 100 in which each of the light guide patterns 123 does not include the plurality of protrusions 123p, and the second light \textcircled{2} emitted from the back-light unit 100 in which each of the light guide patterns 123 includes the plurality of protrusions 123p. FIG. 9 is a view showing light intensities according to azimuth angle of the first light \textcircled{1} and the second light \textcircled{2}.

As shown in FIGS. 8 and 9, the second light \textcircled{2} emitted from the back-light unit 100 with the light guide patterns 123 including the plurality of protrusions 123p can have higher intensities in a central region than the first light \textcircled{1} emitted from the back-light unit 100 with the light guide patterns 123 not including the plurality of protrusions 123p. Thus, in the display apparatus according to another example embodiment of the present disclosure, the diffusion of the light passing through each light guide pattern 123 can be further reduced by the plurality of protrusions 123p disposed at the upper surface of the corresponding light guide pattern 123. That is, in the display apparatus according to another example embodiment of the present disclosure, intensities of the light emitted from the back-light unit 100 toward the people disposed around the user can be greatly reduced. Therefore, in the display apparatus according to another example embodiment of the present disclosure, the accident due to the dispersion of the gaze of the driver disposed around the user (e.g., the passenger) can be greatly reduced in the narrow viewing angle mode. Similarly, with the display apparatus according to another example embodiment of the present disclosure, the user can select the narrow viewing angle mode to prevent others nearby from viewing the image rendered on the display apparatus when the displayed information is not appropriate for viewing by others, e.g., due to the confidentiality or privacy of the displayed information.

The display apparatus according to the example embodiment of the present disclosure described above may include the first control electrode 440 and the second control electrode 450 of the light path conversion unit 400 having a same size. However, in the display apparatus according to another example embodiment of the present disclosure, the liquid crystal molecules of the light path conversion unit 400 can be independently controlled for each region. For example, in the display apparatus according to another example embodiment of the present disclosure, the first control electrode 440 may include a plurality of electrode patterns 440p, and each of the electrode patterns 440p may overlap at least one of the light guide patterns 123, as shown in FIGS. 10 to 12. Each of the electrode patterns 440p may be spaced apart from adjacent electrode patterns 440p. Each of the electrode patterns 440p may be insulated from adjacent electrode patterns 440p. Thus, in the display apparatus according to another example embodiment of the present disclosure, the variable diffusion layer 430 may include, e.g., a first region A1, a second region A2, and a third region A3. Each of the first region A1, the second region A2 and the third region A3 may overlap one of the electrode patterns 440p which are spaced apart from each other. As such, the first region A1, the second region A2 and the third region A3 can be independently controlled. For example, in the display apparatus according to another example embodiment of the present disclosure, the light passing through the first region A1 and the second region A2 of the variable diffusion layer 430 can be diffused, and the straightness of the light passing through the third region A3 of the variable diffusion layer 430 can be increased, as shown in FIG. 12.

In the display apparatus according to another example embodiment of the present disclosure, at least one first light source device 121 overlapping with the first region A1 and at least one first light source device 121 overlapping with the second region A2 can emit light toward the liquid crystal panel 200. Each of the second light source devices 122 overlapping with the third region A3 may emit the light toward a side of adjacent light guide pattern 123. Thus, in the display apparatus according to another example embodiment of the present disclosure, the light having a high diffusion characteristic can be provided to the first region A1 and the second region A2 of the variable diffusion layer 430, and the light having high a straightness characteristic can be provided to the third region A3 of the variable diffusion layer 430.

Here, the image rendered by a region of the liquid crystal panel 200 overlapping with the first region A1 and the second region A2 of the variable diffusion layer 430 can be shared with the people disposed around the user, and the image rendered by a region of the liquid crystal panel 200 overlapping with the third region A3 of the variable diffusion layer 430 can be prevented from viewing by the people disposed around the user. That is, in the display apparatus according to another example embodiment of the present disclosure, the wide viewing angle mode and the narrow viewing angle mode can be simultaneously implemented. For example, in the display apparatus according to another example embodiment of the present disclosure, information necessary or intended for the driver can be provided by a region of the liquid crystal panel 200 overlapping with the first region A1 and the second region A2 of the variable diffusion layer 430, and information or images unnecessary or unintended for the driver can be rendered in a region of the liquid crystal panel 200 overlapping with the third area A3 of the variable diffusion layer 430. Thus, in the display apparatus according to another example embodiment of the present disclosure, the degree of freedom in how to use the display apparatus, including different regions of the display apparatus, can be improved.

The display apparatus according to example embodiments of the present disclosure is described above with a plurality second light source devices 122 disposed between adjacent first light source devices 121. However, in the display apparatus according to another example embodiment of the present disclosure, the first light source devices 121, the second light source devices 122, and the light guide patterns 123 may be arranged in various ways. For example, in the display apparatus according to another example embodiment of the present disclosure, the first light source devices 121 may be disposed at corners of each light guide pattern 123, and the second light source devices 122 may be disposed at sides of each light guide pattern 123, as shown in FIG. 13. The corners of each light guide pattern 123 may have a chamfer shape. Each of the light guide patterns 123 may be surrounded by the first light source devices 121 and the second light source devices 122. The number of the light guide patterns 123 may be different from the number of the second light source devices 122. A single second light source device 122 may be disposed between adjacent first light source devices 121. For example, the number of the second light source devices 122 may be the same as the number of the first light source devices 121. Thus, in the display apparatus according to another example embodiment of the present disclosure, the degree of freedom for the arrangement of the first light source devices 121, the second light source devices 122, and the light guide patterns 123 can be improved.

In the result, the display apparatus according to example embodiments of the present disclosure may include a light path conversion unit disposed between the back-light unit and the liquid crystal panel, wherein the back-light unit may include a light source unit disposed between the base substrate and the optical sheet. The light source unit may include the first light source device, the second light source device, and the light guide pattern, which are disposed side by side on the base substrate. The light provided to the light path conversion unit through the second light source device and the light guide pattern can have a higher straightness than the light provided to the light path conversion unit through the first light source device. That is, in the display apparatus according to example embodiments of the present disclosure, the light provided from the back-light unit in the narrow viewing angle mode can have a lower diffusion characteristic than the light provided from the back-light unit in the wide viewing angle mode. Thus, in the display apparatus according to example embodiments of the present disclosure, a viewing angle of the image rendered in the narrow viewing angle mode can effectively be adjusted. Thereby, in the display apparatus according to the embodiments of the present disclosure, the dispersion of the people's gaze disposed around the user toward the image rendered on the display apparatus can be effectively prevented in the narrow viewing angle mode. And, in the display apparatus according to example embodiments of the present disclosure, power consumption can be reduced by the lower power driving.

It will be apparent to those skilled in the art that the present disclosure is not limited by the above-described example embodiments and the accompanying drawings, and that various substitutions, modifications, and variations can be made in the present disclosure without departing from the spirit or scope of the disclosures. Therefore, the above example embodiments of the present disclosure are provided for illustrative purposes and are not intended to limit the scope or technical concept of the present disclosure. The protective scope of the present disclosure should be construed based on the following claims and their equivalents, and it is intended that the present disclosure cover all modifications and variations of this disclosure that come within the scope of the claims and their equivalents.

What is claimed is:

1. A display apparatus, comprising:
a back-light unit including a light source unit and an optical sheet on the light source unit;
a light path conversion unit on the optical sheet of the back-light unit; and
a display panel on the light path conversion unit,
wherein the light source unit includes a plurality of first light source devices, a plurality of second light source devices, and a plurality of light guide patterns,
wherein the first light source devices are spaced apart from the second light source devices and the light guide patterns and are configured to emit light toward the light conversion unit, and
wherein each of the second light source devices is configured to emit light toward a side of at least one of the light guide patterns.

2. The display apparatus of claim 1, wherein:
the light source unit further includes a base substrate disposed parallel to the optical sheet; and
the first light source devices, the second light source devices, and the light guide patterns are disposed side by side on the base substrate.

3. The display apparatus of claim 1, wherein each of the second light source devices has a different planar shape from each of the first light source devices.

4. The display apparatus of claim 3, wherein each of the second light source devices has a planar shape extending along a side of at least one of the light guide patterns.

5. The display apparatus of claim 1, wherein a number of the second light source devices is different from a number of the first light source devices.

6. The display apparatus of claim 1, wherein a number of the light guide patterns is different from the number of the second light source devices.

7. The display apparatus of claim 1, wherein:
the light path conversion unit includes a first control electrode, a second control electrode, and a variable diffusion layer disposed between the first control electrode and the second control electrode; and
the variable diffusion layer includes a polymer dispersed liquid crystal (PDLC).

8. The display apparatus of claim 7, wherein:
the first control electrode includes a plurality of electrode patterns spaced apart from each other; and
each of the electrode patterns overlaps at least one of the light guide patterns.

9. The display apparatus of claim 1, wherein each of the first light source devices is surrounded by the second light source devices and the light guide patterns.

10. The display apparatus of claim 9, wherein each of the second light source devices is disposed between the first light source devices.

11. A display apparatus, comprising:
a back-light unit;
a liquid crystal panel on the back-light unit; and
a light path conversion unit disposed between the back-light unit and the liquid crystal panel,
wherein the back-light unit includes a base substrate, a light source unit on an upper surface of a base substrate toward the light path conversion unit, and an optical sheet between the light source unit and the light path conversion unit,
wherein the light source unit includes a first light source device configured to emit light toward the light path conversion unit, a light guide pattern spaced apart from the first light source device, and a second light source device disposed at a side of the light guide pattern, and
wherein light transmitted to the light path conversion unit by the second light source device via the light guide pattern has a higher straightness than the light emitted from the first light source device to the light path conversion unit.

12. The display apparatus of claim 11, wherein a corner area of the light guide pattern toward the first light source device has a chamfer shape.

13. The display apparatus of claim 11, wherein:
the optical sheet includes a base sheet and a plurality of prisms disposed on the base sheet; and
the plurality of prisms extend parallel to each other in a first direction.

14. The display apparatus of claim 13, wherein the plurality of prisms are disposed on a lower surface of the base sheet facing toward the light source unit.

15. The display apparatus of claim 13, wherein:
an upper surface of the light guide pattern facing toward the optical sheet includes a plurality of protrusions;
a cross-section of each of the plurality of protrusions has a shape corresponding to a cross-section of each of the plurality of prisms; and
the plurality of protrusions extend in a second direction intersecting the first direction.
